(19) United States
(12) Patent Application Publication
(10) Pub. No.: US 2025/0023140 A1
(43) Pub. Date: Jan. 16, 2025

(54) BATTERY PACK

(71) Applicant: MURATA MANUFACTURING CO., LTD., Kyoto (JP)

(72) Inventor: Hideyasu TAKATSUJI, Kyoto (JP)

(21) Appl. No.: 18/897,243

(22) Filed: Sep. 26, 2024

Related U.S. Application Data
(63) Continuation of application No. PCT/JP2023/002937, filed on Jan. 30, 2023.

(30) Foreign Application Priority Data
Mar. 30, 2022 (JP) 2022-057362

(51) Int. Cl. H01M 10/6554; H01M 50/213; H01M 50/238; H01M 50/244; H01M 50/289

(52) U.S. Cl. CPC H01M 10/6554; H01M 50/213; H01M 50/238; H01M 50/244; H01M 50/289

(57) ABSTRACT

A battery pack is provided and includes a battery cell assembly including a plurality of battery cells and a battery holder in which the plurality of battery cells are stored; and an exterior case that includes a bottom plate and a plurality of side plates intersecting with the bottom plate at a peripheral edge of the bottom plate and stores the battery holder, in which the battery holder has a side portion facing the side plate of the exterior case, the battery holder is provided with at least one protruding portion protruding from the side portion, the side plate of the exterior case is provided with a through hole into which the protruding portion is inserted, a portion of the battery cell assembly is in contact with an inner surface of the side plate of the exterior case, and a distance between an outer surface corresponding to the first side portion and an outer surface corresponding to the second side portion of the battery cell assembly when the battery holder is not stored in the exterior case is equal to or longer than a distance between the first side plate and the second side plate of the exterior case.

### CROSS REFERENCE TO RELATED APPLICATIONS

The present application is a continuation of PCT patent application no. PCT/JP2023/002937, filed on Jan. 30, 2023, which claims priority to Japanese patent application no. 2022-057362, filed on Mar. 30, 2022, the entire contents of which are incorporated herein by reference.

### BACKGROUND

The present disclosure relates to a battery pack.

A battery pack including a battery cell assembly having a plurality of battery cells held in a battery holder and an exterior case in which the battery cell assembly is stored is known.

### SUMMARY

The present disclosure relates to a battery pack.

Such a battery pack is required to efficiently dissipate heat generated by the battery cells to the outside in order to suppress a temperature rise of the battery cells during normal use. In the battery pack described in the Background section, a friction reducing sheet is provided between a heat dissipation sheet and the case, and there is a possibility that the friction reducing sheet becomes thermal resistance and heat cannot be efficiently dissipated. In addition, since the contact area between the battery holder and the case (or the heat dissipation sheet) is small, there is a possibility that heat cannot be efficiently dissipated.

The present disclosure, in an embodiment, relates to providing a battery pack capable of improving heat dissipation.

A battery pack of an embodiment of the present disclosure includes: a battery cell assembly including a plurality of battery cells and a battery holder in which the plurality of battery cells are stored; and an exterior case that includes a bottom plate and a plurality of side plates intersecting with the bottom plate at a peripheral edge of the bottom plate and stores the battery holder, in which the battery holder has a side portion facing the side plate of the exterior case, in which the battery holder is provided with at least one protruding portion protruding from the side portion, in which the side plate of the exterior case is provided with a through hole into which the protruding portion is inserted, in which a portion of the battery cell assembly is in contact with an inner surface of the side plate of the exterior case, in which the plurality of side plates of the exterior case include a first side plate and a second side plate opposed to the first side plate, in which the side portion of the battery holder includes a first side portion facing the first side plate and a second side portion on a side opposite to the first side portion and facing the second side plate, and in which a distance between an outer surface corresponding to the first side portion and an outer surface corresponding to the second side portion of the battery cell assembly when the battery holder is not stored in the exterior case is equal to or longer than a distance between the first side plate and the second side plate of the exterior case.

According to the battery pack of the present disclosure, heat dissipation can be improved according to an embodiment.

### BRIEF DESCRIPTION OF THE FIGURES

FIG. 1 is a perspective view schematically illustrating a battery pack according to an embodiment.

FIG. 2 is an exploded perspective view schematically illustrating the battery pack according to an embodiment in an exploded manner.

FIG. 3 is a sectional view taken along line III-III′ of FIG. 1.

FIG. 4 is a sectional view taken along line IV-IV′ of FIG. 3.

FIG. 5 is an explanatory view illustrating an operation example of storing a battery holder in an exterior case.

FIG. 6 is a graph schematically illustrating a relationship between a tensile elongation and a flexural modulus of each of a battery holder material and an exterior case material.

FIG. 7 is a perspective view schematically illustrating a battery pack according to an embodiment.

FIG. 8 is an exploded perspective view schematically illustrating the battery pack according to an embodiment in an exploded manner.

FIG. 9 is an exploded perspective view schematically illustrating the battery pack and a battery holder according to an embodiment in an exploded manner.

FIG. 10 is an enlarged perspective view illustrating a protruding portion in a part of the battery holder according to an embodiment.

FIG. 11 is a sectional view schematically illustrating the battery pack according to an embodiment.

FIG. 12 is a top view of an exterior case according to an embodiment.

FIG. 13 is a sectional view taken along line XIII-XIII′ of FIG. 12.

FIG. 14 is an explanatory diagram illustrating an operation example of storing the battery holder according to an embodiment in the exterior case.

FIG. 15 is a sectional view schematically illustrating a battery pack according to an embodiment.

FIG. 16 is a side view schematically illustrating a heat dissipation sheet.

FIG. 17 is an exploded perspective view schematically illustrating a battery pack and a battery holder according to an embodiment in an exploded manner.

FIG. 18 is an enlarged perspective view illustrating a protruding portion in a part of the battery holder according to an embodiment.

FIG. 19 is a sectional view schematically illustrating the battery pack according to an embodiment.

FIG. 20 is a side view illustrating a protruding portion of a battery holder and a through hole of an exterior case according to an embodiment.

FIG. 21 is a sectional view taken along line XXI-XXI′ of FIG. 20.

FIG. 22 is a side view illustrating a protruding portion of a battery holder and a through hole of an exterior case according to an embodiment.

FIG. 23 is a sectional view taken along line XXIII-XXIII′ of FIG. 22.

### DETAILED DESCRIPTION

The present disclosure will be described in further detail including with reference to the drawings according to an embodiment. Note that the present disclosure is not limited thereto. Each embodiment is illustrative, and replacement and combination of a part of configurations illustrated in the different embodiments can be performed. In a second embodiment and subsequent embodiments, matters common to those of the first embodiment will not be described, and only differences will be described. In particular, a similar effect by a similar structure will not be sequentially referred to for each embodiment.

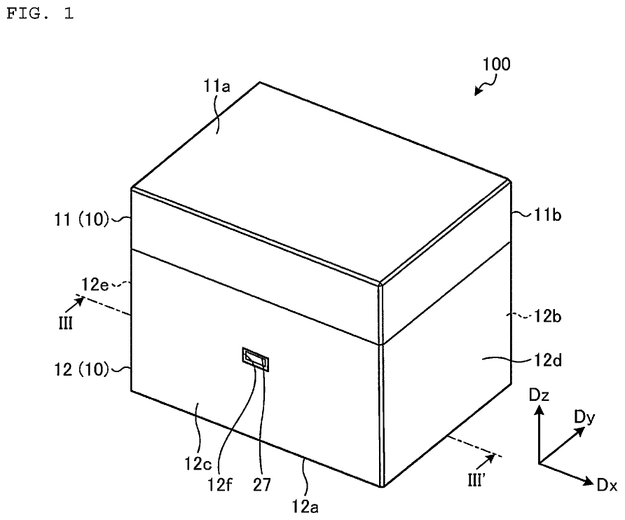

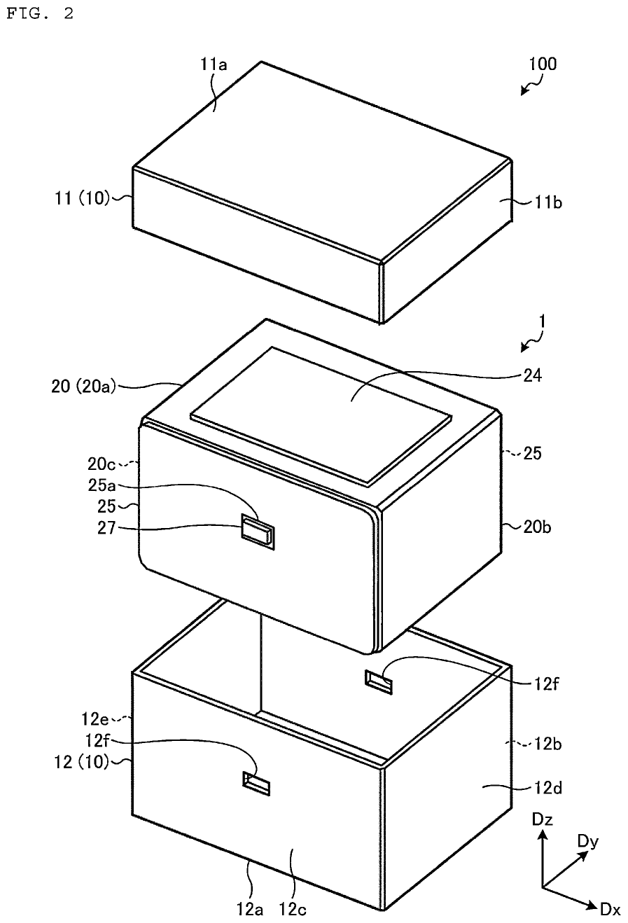

FIG. 1 is a perspective view schematically illustrating a battery pack according to a first embodiment. FIG. 2 is an exploded perspective view schematically illustrating the battery pack according to the first embodiment in an exploded manner. As illustrated in FIGS. 1 and 2, a battery pack 100 according to the first embodiment includes an exterior case 10 and a battery cell assembly 1. The battery holder 20, the heat dissipation sheet 25, and the substrate 24 are stored inside the exterior case 10.

The exterior case 10 includes a first exterior case 11 and a second exterior case 12. The first exterior case 11 has a recessed shape including a top plate 11a and a plurality of side plates 11b provided on a peripheral edge of the top plate 11a. An opening is provided on a side opposite to the top plate 11a of the first exterior case 11, and ends (lower ends in FIGS. 1 and 2) of the plurality of side plates 11b are formed as open ends.

The second exterior case 12 has a recessed shape including a bottom plate 12a and a plurality of side plates 12b, 12c, 12d, and 12e intersecting the bottom plate 12a at a peripheral edge of the bottom plate 12a. An opening is provided on a side opposite to the bottom plate 12a of the second exterior case 12, and ends (upper ends in FIG. 1) of the side plates 12b, 12c, 12d, and 12e are formed as open ends. The first exterior case 11 and the second exterior case 12 are combined such that their open ends face each other. The first exterior case 11 and the second exterior case 12 are fixed by a holding member (not illustrated) including a screw or the like in a state where the battery cell assembly 1 is stored in the internal space.

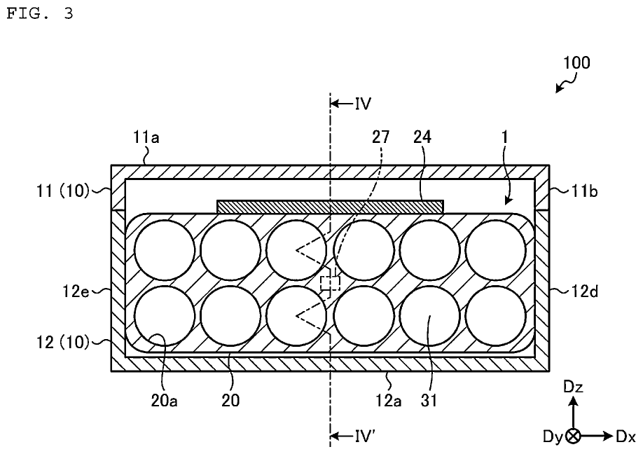

The battery cell assembly 1 includes a plurality of battery cells 31 (see FIG. 3), a battery holder 20 in which the plurality of battery cells 31 are stored, a substrate 24, and a heat dissipation sheet 25. The battery holder 20 includes a side portion 20b facing the side plate 12b and a side portion 20c facing the side plate 12c on the side opposite to the side portion 20b when stored in the exterior case 10. The battery holder 20 is provided with protruding portions 27 protruding from the side portions 20b and 20c (in FIG. 2, the protruding portion 27 of the side portion 20b is not illustrated). The side plates 12b and 12c of the second exterior case 12 are respectively provided with through holes 12f into which protruding portions 27 are inserted. Detailed configurations of the battery holder 20 and the protruding portion 27 will be described below with reference to FIG. 3.

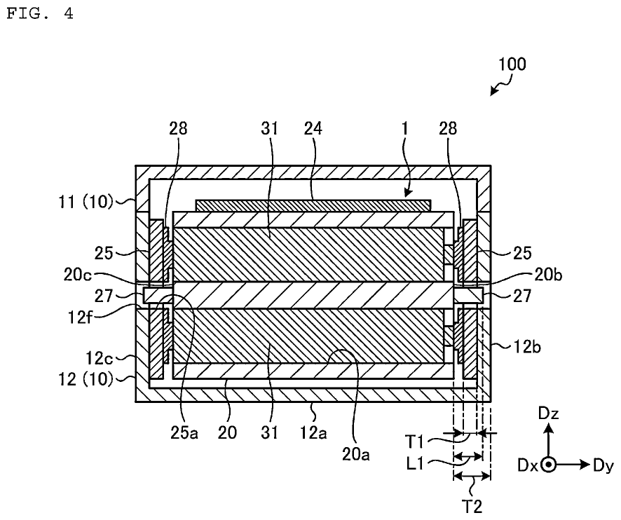

The substrate 24 is attached to an upper surface of the battery holder 20. For example, a protection circuit for ensuring the safety of the battery pack 100 is formed on the substrate 24. The protective circuit of the substrate 24 is electrically connected to the plurality of battery cells 31 stored inside the battery holder 20 with a battery connecting portion 28 (see FIG. 4) interposed therebetween.

The heat dissipation sheet 25 is provided on each of the side portion 20b and the side portion 20c of the battery holder 20. The heat dissipation sheet 25 is provided with an opening 25a at a position overlapping the protruding portion 27. The protruding portion 27 penetrates the opening 25a and protrudes toward the side plates 12b and 12c. When the battery holder 20 is stored in the exterior case 10, the heat dissipation sheet 25 is arranged in close contact with the side plates 12b and 12c of the second exterior case 12. The heat dissipation sheet 25 is formed of, for example, a silicone resin or the like containing a carbon-based material having good thermal conductivity. The heat dissipation sheet 25 may be attached to the battery holder 20 by any method. When the silicone resin described above is used as the heat dissipation sheet 25, the heat dissipation sheet 25 can be attached to the battery holder 20 using its adhesiveness.

FIG. 3 is a sectional view taken along line III-III′ of FIG. 1. FIG. 4 is a sectional view taken along line IV-IV′ of FIG. 3. As illustrated in FIG. 3, the battery holder 20 has a plurality of battery storage portions 20a. Each of the plurality of battery storage portions 20a is formed in a cylindrical shape and is arranged in a first direction Dx and a third direction Dz. The plurality of battery cells 31 are individually stored in the plurality of battery storage portions 20a. The plurality of battery cells 31 stored in the plurality of battery storage portions 20a are cylindrical batteries, are arranged side by side in the first direction Dx and the third direction Dz, and extend in a second direction Dy. The positive electrodes and the negative electrodes of the plurality of battery cells 31 are arranged toward one side and the other side in the second direction Dy, respectively.

In the following description, one direction in a plane parallel to a plane including the bottom plate 12a of the second exterior case 12 is referred to as the first direction Dx. A direction orthogonal to the first direction Dx in a plane parallel to a plane including the bottom plate 12a is defined as the second direction Dy. A direction orthogonal to each of the first direction Dx and the second direction Dy is defined as the third direction Dz. The third direction Dz is a direction perpendicular to the surface of the bottom plate 12a. In addition, in the present specification, the plan view indicates a positional relationship when viewed from the third direction Dz.

In the third direction Dz, a direction from the bottom plate 12a of the second exterior case 12 toward the top plate 11a of the first exterior case 11 may be referred to as up or an upper side, and a direction from the top plate 11a of the first exterior case 11 toward the bottom plate 12a of the second exterior case 12 may be referred to as down or a lower side.

As illustrated in FIG. 3, the side plates 12b and 12c of the second exterior case 12 are respectively arranged on one end side and the other end side in the extending direction of the plurality of battery cells 31. As illustrated in FIG. 4, the side plates 12d and 12e of the second exterior case 12 are arranged along the extending direction of the plurality of battery cells 31. The widths of the side plates 12b and 12c of the second exterior case 12 in the first direction Dx are longer than the widths of the side plates 12d and 12e of the second exterior case 12 in the second direction Dy. That is, in plan view, the longitudinal direction of the second exterior case 12 is a direction parallel to the first direction Dx, and the lateral direction is a direction parallel to the second direction Dy.

As illustrated in FIG. 4, the side portion 20b (first side portion) of the battery holder 20 is provided on one end side in the extending direction of the plurality of battery cells 31, and the side portion 20c (second side portion) is provided on the side opposite to the side portion 20b and on the other end side in the extending direction of the plurality of battery cells 31. The side portion 20b of the battery holder 20 is arranged so as to face the side plate 12b (first side plate) of the second exterior case 12. The side portion 20c of the battery holder 20 is arranged so as to face the side plate 12c (second side plate) of the second exterior case 12.

The battery connecting portion 28 and the heat dissipation sheet 25 are provided between the side portion 20b of the battery holder 20 and the side plate 12b of the second exterior case 12, and between the side portion 20c of the battery holder 20 and the side plate 12c of the second exterior case 12, respectively.

The battery connecting portion 28 is formed of a conductive metal plate, and is connected to positive and negative electrodes of the plurality of battery cells 31. The plurality of battery cells 31 are connected in parallel or in series by the battery connecting portion 28, and are electrically connected to the substrate 24. Although the detailed configuration of the battery connecting portion 28 is omitted, the battery connecting portion 28 is appropriately arranged according to the connection configuration of the plurality of battery cells 31. For example, the battery connecting portion 28 may be configured such that all the plurality of battery cells 31 are connected in series. Alternatively, the battery connecting portion 28 may be configured such that the plurality of battery cells 31 arranged in the third direction Dz are connected in parallel, and the plurality of battery cells 31 arranged in the first direction Dx are connected in series.

The heat dissipation sheet 25 is bonded to an outer surface (surface of the second exterior case 12 facing the side plates 12b and 12c) of the battery connecting portion 28. The heat dissipation sheet 25 is provided so as to cover substantially the entire surfaces of the battery connecting portion 28 and the side portions 20b and 20c of the battery holder 20. The heat dissipation sheet 25 is in contact with the inner surfaces of the side plates 12b and 12c of the second exterior case 12.

The protruding portion 27 is provided on each of the side portions 20b and 20c of the battery holder 20, and protrudes to one side and the other side in the second direction Dy. The protruding portion 27 is made of the same material as the battery holder 20, and is formed integrally with the battery holder 20. As described above, the through holes 12f are formed in the side plates 12b and 12c of the second exterior case 12 at positions overlapping the protruding portions 27. As illustrated in FIGS. 2 and 3, in the present embodiment, the protruding portions 27 are provided at the central portions of the side portions 20b and 20c of the battery holder 20. Further, the through holes 12f are formed in central portions of the side plates 12b and 12c of the second exterior case 12.

As illustrated in FIG. 4, an opening 25a is also provided at a position overlapping the protruding portion 27 of the heat dissipation sheet 25. The through hole 12f and the opening 25a are provided to be connected in the second direction Dy. The protruding portions 27 pass through the openings 25a of the heat dissipation sheet 25 and are respectively inserted into the through holes 12f of the side plates 12b and 12c of the second exterior case 12. By inserting the protruding portion 27 into the through hole 12f, the positions of the battery holder 20 in the first direction Dx and the third direction Dz are regulated. A part of the battery cell assembly 1 (heat dissipation sheet 25) is in contact with the inner surfaces of the side plates 12b and 12c of the second exterior case 12, so that the position of the battery holder 20 in the second direction Dy is regulated.

A length L1 of the protruding portion 27 in the extending direction is longer than at least a thickness T1 of the heat dissipation sheet 25. In addition, the length L1 of the protruding portion 27 in the extending direction is shorter than a total thickness T2 of the battery connecting portion 28, the heat dissipation sheet 25, and the side plate 12b. As a result, the tip of the protruding portion 27 is positioned inside the through hole 12f. However, the present disclosure is not limited to this, and the tip of the protruding portion 27 may be provided so as to coincide with the outer surfaces of the side plates 12b and 12c of the second exterior case 12, or may protrude to the outside. The thickness of the protruding portion 27 in the third direction Dz is smaller than the width of the through hole 12f in the third direction Dz, and the width of the protruding portion 27 in the first direction Dx is smaller than the width of the through hole 12f in the first direction Dx. The protruding portion 27 has a rectangular shape in a sectional view and has a constant thickness along the extending direction. Thus, the strength of the protruding portion 27 can be improved.

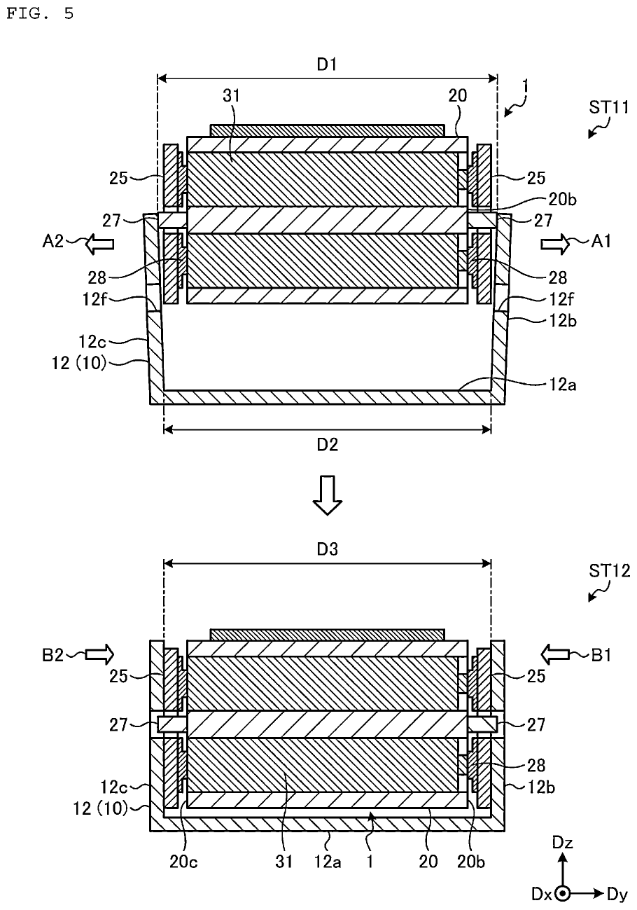

Next, in the battery pack 100 of the present embodiment, a configuration for forming a high close contact state between the side plates 12b and 12c of the second exterior case 12 and the heat dissipation sheet 25 will be described. FIG. 5 is an explanatory diagram illustrating an operation example of storing the battery holder in the exterior case.

As illustrated in FIG. 5, when the battery holder 20 is stored in the second exterior case 12, and the protruding portion 27 is located between the upper ends of the side plates 12b and 12c and the through hole 12f in the third direction Dz, the side plate 12b and the side plate 12c are pushed and expanded in a direction (arrows A1 and A2 in FIG. 5) in which the side plates 12b and 12c are separated from each other by the protruding portion 27 (step ST11). In this state, a first distance D1 between the side plate 12b and the side plate 12c at the upper end is larger than a second distance D2 between the side plate 12b and the side plate 12c in a state where the battery holder 20 is not stored in the second exterior case 12. In the example illustrated in FIG. 5, the second distance D2 is substantially equal to the distance between the side plate 12b and the side plate 12c on the lower end side (bottom plate 12a side).

The width (excluding the protruding portion 27) of the battery cell assembly 1 in the second direction Dy in a state where the battery holder 20 is not stored in the second exterior case 12 is equal to or larger than the second distance D2. In the example illustrated in FIG. 5, the width (excluding the protruding portion 27) of the battery cell assembly 1 in the second direction Dy is a distance in the second direction Dy between the outer surface (the outer surface corresponding to the side portion 20b) of one heat dissipation sheet 25 and the outer surface (the outer surface corresponding to the side portion 20c) of the other heat dissipation sheet 25.

When the battery holder 20 is further pushed toward the bottom plate 12a from step ST11, the first distance D1 between the side plate 12b and the side plate 12c is gradually increased by the protruding portion 27. When the protruding portion 27 is inserted into the through hole 12f, the stress of the side plates 12b and 12c of the second exterior case 12 is released, and the side plates 12b and 12c return to the direction approaching each other (arrows B1 and B2 in FIG. 5) by the elastic deformation (step ST12). As a result, the side plates 12b and 12c are elastically deformed so as to sandwich the battery cell assembly 1 in the second direction Dy, and a highly close contact state with the heat dissipation sheet 25 is created. In this state, the third distance D3 between the side plate 12b and the side plate 12c at the upper end is smaller than the first distance D1 in step ST11.

FIG. 6 is a graph schematically illustrating the relationship between the tensile elongation and the flexural modulus of each of the battery holder material and the exterior case material. The evaluation of the tensile elongation was performed based on ISO 527-1, 2. The evaluation of the flexural modulus was performed based on ISO 178. As illustrated in FIG. 6, the battery holder 20 and the protruding portion 27 are made of a material having a flexural modulus of 2000 MPa or more and a tensile elongation of less than 5%. The material of the battery holder 20 and the protruding portion 27 is preferably a hard material, and for example, a material such as polyether ether ketone (PEEK), polyphenylene sulfide (PPS), or polyamide (PA) reinforced with a filler such as glass fiber is used.

The second exterior case 12 (exterior case 10) is made of a material having a flexural modulus of less than 2000 MPa and a tensile elongation of 5% or more. As a material of the second exterior case 12 (exterior case 10), a material which is easily elastically deformed is preferable. For example, an alloy resin material in which rubber or elastomer is blended is more preferable. As a base material, polyester such as polypropylene (PP), polyethylene terephthalate (PET), polycarbonate (PC), or polyphenylene ether (PPE), or a polystyrene-based material is more preferable.

By using these materials, when the battery holder 20 is stored in the second exterior case 12 (FIG. 5, Step ST11), deformation of the protruding portion 27 is suppressed, and the side plates 12b and 12c can be satisfactorily pushed and expanded by the protruding portion 27. In addition, plastic deformation of the second exterior case 12 is suppressed, and when the protruding portion 27 is inserted into the through hole 12f (FIG. 5, Step ST12), the side plates 12b and 12c of the second exterior case 12 can be elastically deformed so as to sandwich the battery cell assembly 1 in the second direction Dy.

With such a configuration, when the battery holder 20 is stored in the second exterior case 12 (step ST11), contact between the heat dissipation sheet 25 and the side plates 12b and 12c is suppressed. Therefore, when a material having adhesiveness is used as the heat dissipation sheet 25, the battery pack 100 can suppress peeling or breakage of the heat dissipation sheet 25 when the battery holder 20 is stored in the second exterior case 12.

When the protruding portion 27 is inserted into the through hole 12f, a part (in the example illustrated in FIGS. 4 and 5, the heat dissipation sheet 25) of the battery cell assembly 1 is provided in close contact with the inner surfaces of the side plates 12b and 12c of the second exterior case 12. More specifically, it is possible to realize a high close contact state between the heat dissipation sheet 2 and the side plates 12b and 12c in a state where the heat dissipation sheet 25 covers substantially the entire surfaces of the battery connecting portion 28 and the side portions 20b and 20c of the battery holder 20 without interposing other members such as a low friction body and a thermal coupling portion between the heat dissipation sheet 25 and the side plates 12b and 12c. As a result, heat generated on the positive electrode side and the negative electrode side of each of the plurality of battery cells 31 is effectively transferred to the second exterior case 12 via the battery connecting portion 28 and the heat dissipation sheet 25, and is dissipated to the outside.

The through holes 12f are provided in the side plates 12b and 12c along the longitudinal direction of the second exterior case 12, and the protruding portions 27 are provided on the side portions 20b and 20c of the battery holder 20 facing the side plates 12b and 12c. In other words, the protruding portion 27 of the battery holder 20 is not provided at positions facing the side plates 12d and 12e along the lateral direction of the second exterior case 12. As a result, the side plates 12b and 12c along the longitudinal direction are more easily elastically deformed than the side plates 12d and 12e in the lateral direction, so that the battery holder 20 can be smoothly incorporated into the second exterior case 12.

Note that the numbers, positions, shapes, and the like of the protruding portions 27 and the through holes 12f are merely examples, and can be appropriately changed. Further, the configuration of the battery cell assembly 1 is merely an example, and can be appropriately changed. For example, the battery cell assembly 1 may not include the heat dissipation sheet 25. In this case, the battery connecting portion 28 or the side portions 20b and 20c of the battery holder 20 are provided in close contact with the inner surfaces of the side plates 12b and 12c of the second exterior case 12. The configuration of the battery holder 20 is also only schematically illustrated, and may have any configuration.

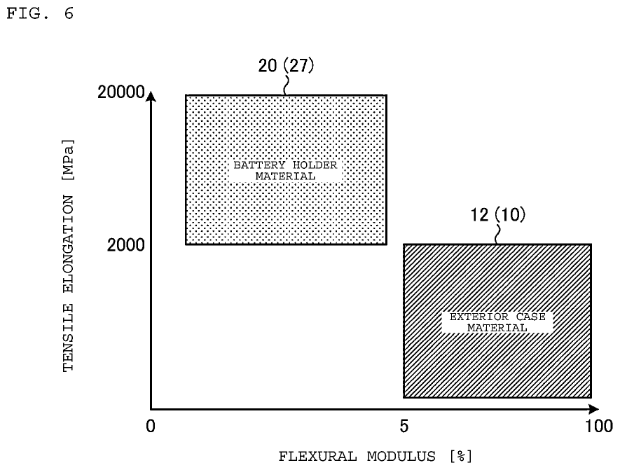

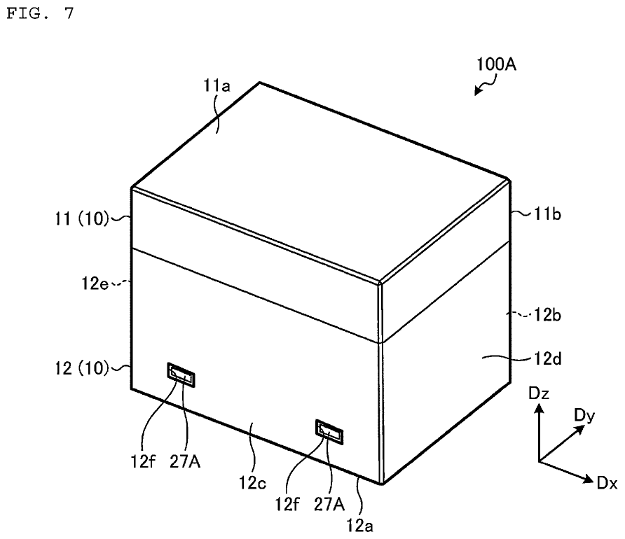

FIG. 7 is a perspective view schematically illustrating a battery pack according to a second embodiment. FIG. 8 is an exploded perspective view schematically illustrating the battery pack according to the second embodiment in an exploded manner. In the second embodiment, a configuration in which protruding portions 27A and the through holes 12f are provided on the bottom plate 12a side in the third direction Dz will be described.

As illustrated in FIGS. 7 and 8, in a battery pack 100A of the second embodiment, the protruding portions 27A are provided on the lower end side of the side portions 20b and 20c of the battery holder 20 in the third direction Dz. Two protruding portions 27A are provided on the respective side portions 20b and 20c, and are arranged side by side in the first direction Dx. The through holes 12f of the second exterior case 12 are provided on the lower end side of the side plates 12b and 12c in the third direction Dz. In other words, the height positions of the plurality of through holes 12f are provided at positions closer to the bottom plate 12a than the upper ends of the side plate 12b and the side plate 12c. In other words, the height positions of the plurality of protruding portions 27A are provided at positions closer to the bottom plate 12a than the upper ends of the side plate 12b and the side plate 12c. In addition, two through holes 12f are provided in each of the side plates 12b and 12c, and are arranged side by side in the first direction Dx.

The openings 25a of the heat dissipation sheet 25 are also provided on the lower end side of the heat dissipation sheet 25 so as to correspond to the protruding portions 27A and the through holes 12f. In addition, two openings 25a are arranged side by side in the first direction Dx in one heat dissipation sheet 25.

On the inner surfaces of the side plates 12b and 12c of the second exterior case 12, groove portions 12g extending between the through holes 12f and the upper ends of the side plates 12b and 12c are provided. The groove portion 12g is formed as a guide groove of the protruding portion 27A when the battery holder 20 is stored in the second exterior case 12. The protruding portion 27A moves along the groove portion 12g and is guided to the through hole 12f. As a result, in a case where the through holes 12f are provided on the lower end side of the side plates 12b and 12c and the moving distances of the protruding portions 27A to the through holes 12f are long, or in a configuration in which a plurality of protruding portions 27A are provided on one side portion 20b, the protruding portions 27A can be easily inserted into the through holes 12f.

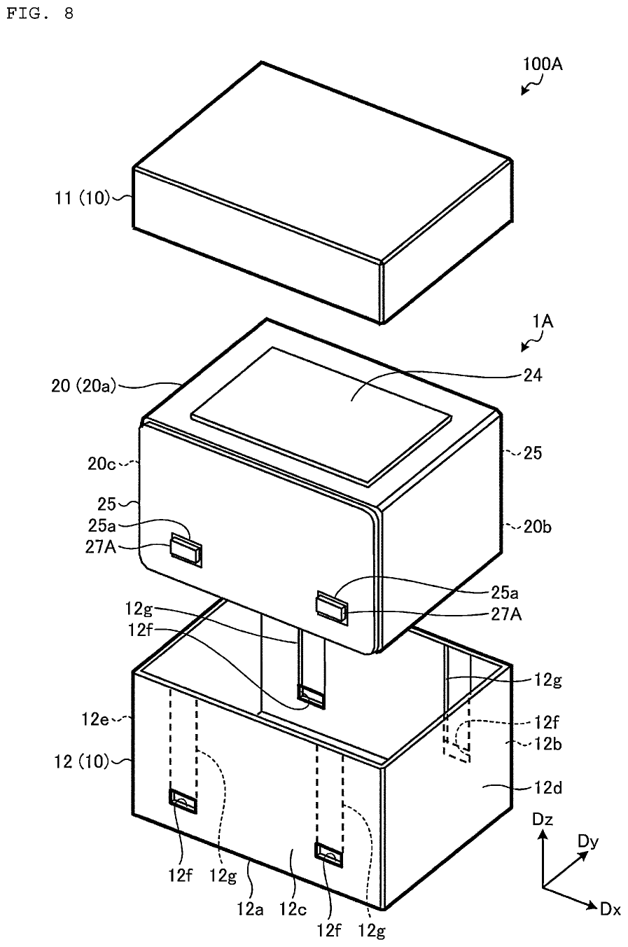

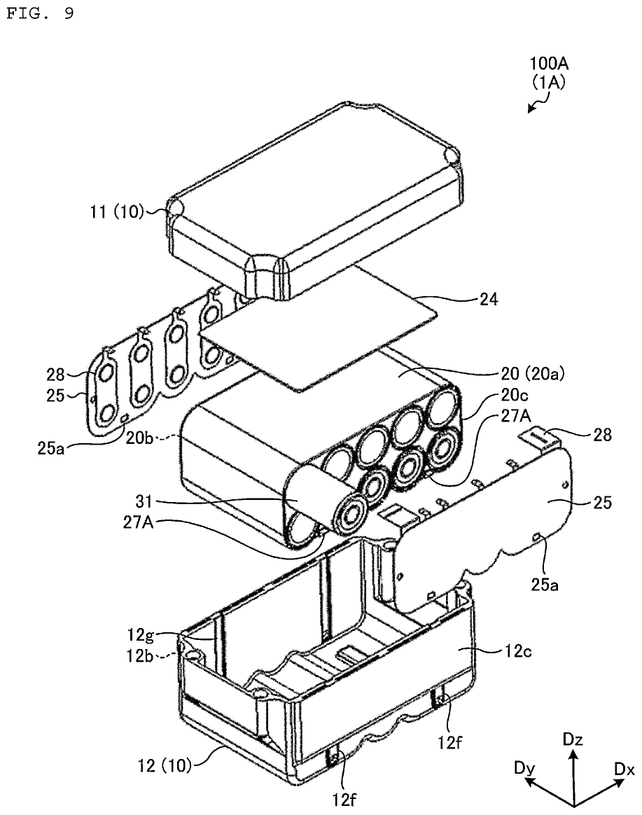

FIG. 9 is an exploded perspective view schematically illustrating the battery pack and the battery holder according to the second embodiment in an exploded manner. FIG. 10 is an enlarged perspective view illustrating the protruding portion in a part of the battery holder according to the second embodiment. FIGS. 9 and 10 illustrate a more detailed configuration example of the battery pack 100A illustrated in FIG. 8. As illustrated in FIG. 9, the plurality of battery connecting portions 28 of the battery cell assembly 1A are provided on the positive electrode and negative electrode sides of the battery cells 31, and are arranged side by side in the first direction Dx. The heat dissipation sheet 25 is continuously provided over the plurality of battery connecting portions 28.

In FIG. 10, a region C1 surrounded by a dotted line is enlarged together with a perspective view of the battery cell assembly 1A. The protruding portion 27 of the first embodiment described above has a rectangular shape in a sectional view, whereas the protruding portion 27A has a tapered shape as illustrated in FIG. 10. Specifically, the protruding portion 27A becomes thinner as a distance from the side portions 20b and 20c increases, that is, as a distance to the tip decreases in the extending direction. The upper surface of the protruding portion 27A extends in a direction parallel to the second direction Dy and is formed flat. Further, the lower surface of the protruding portion 27A is formed to have a curved surface. Accordingly, when the battery holder 20 is stored in the second exterior case 12, contact resistance between the protruding portions 27A and the side plates 12b and 12c is suppressed, and the protruding portions 27A can smoothly move along the groove portions 12g.

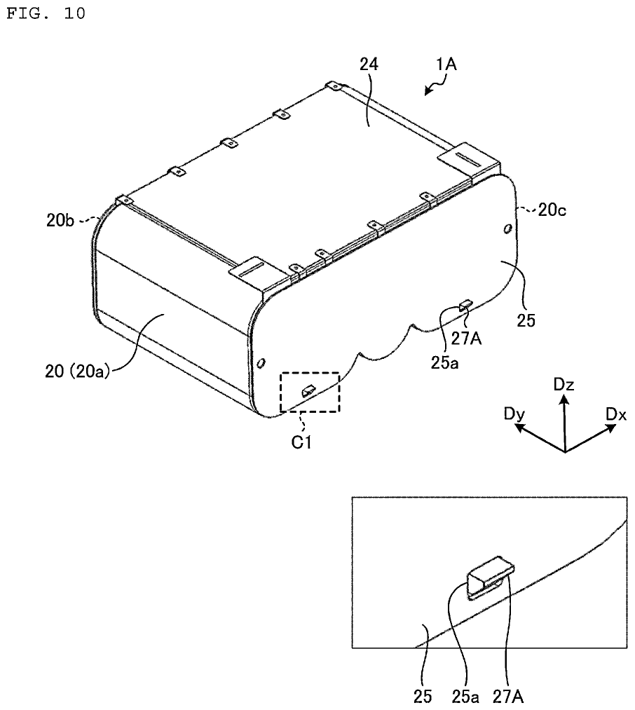

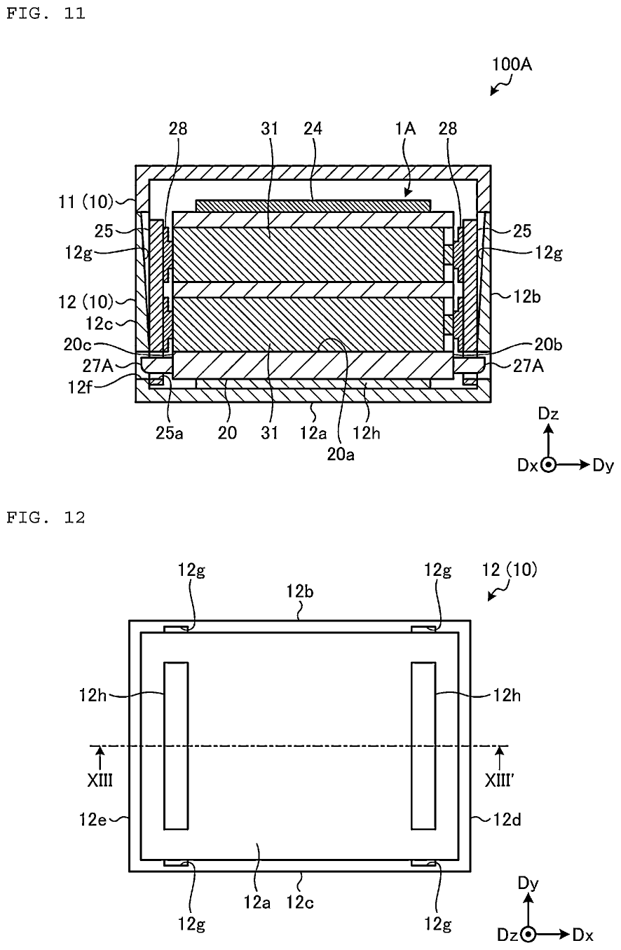

FIG. 11 is a sectional view schematically illustrating the battery pack according to the second embodiment. FIG. 12 is a top view of the exterior case according to the second embodiment. FIG. 13 is a sectional view taken along line XIII-XIII of FIG. 12. As illustrated in FIG. 11, also in the battery pack 100A of the second embodiment, the protruding portions 27A are inserted into the through holes 12f, so that the battery cell assembly 1A is stored so as to be sandwiched between the side plates 12b and 12c of the second exterior case 12. FIG. 11 illustrates a sectional view of the groove portion 12g, and a gap is formed between the groove portion 12g and the heat dissipation sheet 25. However, in a portion where the groove portion 12g is not formed, the heat dissipation sheet 25 and the side plates 12b and 12c of the second exterior case 12 are provided in close contact with each other as in the first embodiment (see FIG. 4).

The groove portion 12g has an inclined surface where the depth in the second direction Dy increases from the through hole 12f toward the upper ends of the side plates 12b and 12c. As illustrated in FIG. 13, the groove portion 12g has the same width as the through hole 12f, and is provided continuously from the through hole 12f to the upper ends of the side plates 12b and 12c. Accordingly, when the battery holder 20 is stored in the second exterior case 12, contact resistance between the protruding portion 27A having a tapered shape and the inclined surface of the groove portion 12g is suppressed, and the battery holder 20 can smoothly move along the groove portion 12g.

As illustrated in FIGS. 11 to 13, pedestals 12h that support the battery holder 20 are provided on the bottom plate 12a of the second exterior case 12. The pedestals 12h are provided so as to protrude upward in the third direction Dz from the bottom plate 12a, and extend in the second direction Dy in plan view. In the present embodiment, the two pedestals 12h are arranged side by side in the first direction Dx. The two pedestals 12h are provided at positions corresponding to the through holes 12f and the groove portions 12g, respectively. In other words, as illustrated in FIG. 12, in plan view, the pedestals 12h are provided between the groove portions 12g of the side plate 12b and the groove portions 12g of the opposing side plate 12c in the second direction Dy.

By providing the pedestals 12h, when predetermined clearances are provided between the through holes 12f and the protruding portions 27A, the bottom portion of the battery holder 20 comes into contact with the pedestals 12h when the battery holder 20 is stored in the second exterior case 12, whereby the height position of the battery holder 20 can be defined. In other words, when the battery holder 20 is stored in the second exterior case 12, the height position of the battery holder 20 can be easily defined in a region where the state on the bottom plate 12a side of the battery holder 20 cannot be visually recognized.

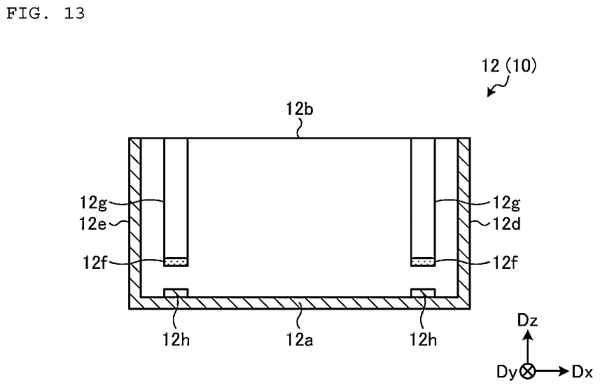

FIG. 14 is an explanatory diagram illustrating an operation example of storing the battery holder according to the second embodiment in the exterior case. In FIG. 14, a part of the protruding portion 27A of the battery holder 20 and the through hole 12f of the side plate 12b are illustrated in an enlarged manner.

As illustrated in FIG. 14, when the battery holder 20 is stored in the second exterior case 12, the battery holder 20 is moved in a direction (downward) of approaching the second exterior case 12 (step ST21). In step ST21, the protruding portion 27A and the side plate 12b are in a non-contact state, and the side plate 12b is not deformed.

The protruding portion 27A comes into contact with the groove portion 12g of the side plate 12b, and storage of the battery holder 20 is started (step ST22). Since the groove portion 12g is provided and the groove portion 12g has the inclined surface, the deformation amount of the side plate 12b at the start of storing the battery holder 20 is suppressed to be small. In other words, as compared with the case where there is no groove portion 12g, it is possible to reduce the force of pushing the battery holder 20 toward the second exterior case 12 side at the start of storage. Here, since the protruding portion 27A is provided on the lower end side of the side plate 12b, the area of the heat dissipation sheet 25 below the protruding portion 27A is smaller (the length in the third direction Dz is shorter) than that in the first embodiment described above. Therefore, it is possible to suppress the contact between the heat dissipation sheet 25 and the side plate 12b at the start of storage.

The battery holder 20 further moves downward while the side plate 12b is pushed and expanded by the protruding portion 27A (step ST23). Here, as described with reference to FIGS. 7 to 10, since two protruding portions 27A are provided on one side portion 20b, when the battery holder 20 moves downward, a force is applied from the two protruding portions 27A to the side plate 12b, and the side plate 12b can be favorably pushed and spread. In addition, since the protruding portion 27A has a tapered shape, contact resistance with the inclined surface of the groove portion 12g is suppressed, and the side plate 12b can be smoothly moved along the groove portion 12g while being pushed and expanded.

From step ST23, when the battery holder 20 is further pushed into the bottom plate 12a (see FIG. 11 and the like) side and the protruding portion 27A is inserted into the through hole 12f, the stress of the side plate 12b of the second exterior case 12 is released, and the second exterior case 12 returns by elastic deformation (step ST24). Although not illustrated in FIG. 14, a similar operation is performed on the side plate 12c on the side opposite to the side plate 12b, so that the side plates 12b and 12c are elastically deformed so as to sandwich the battery cell assembly 1 in the second direction Dy, and a high close contact state with the heat dissipation sheet 25 is created.

Note that the configuration of the battery pack 100A of the second embodiment is merely an example, and can be appropriately changed. For example, three or more protruding portions 27A may be provided on one side portion 20b, and in this case, three or more through holes 12f may be provided in one side plate 12b. The groove portion 12g is not limited to the configuration having the inclined surface, and may be formed at a constant depth from the through hole 12f to each of the upper ends of the side plates 12b and 12c. The number, position, shape, and the like of the pedestals 12h can be appropriately changed as long as the pedestals 12h do not come into contact with members such as the battery connecting portion 28 and the heat dissipation sheet 25 of the battery cell assembly 1. The pedestal 12h may not be provided.

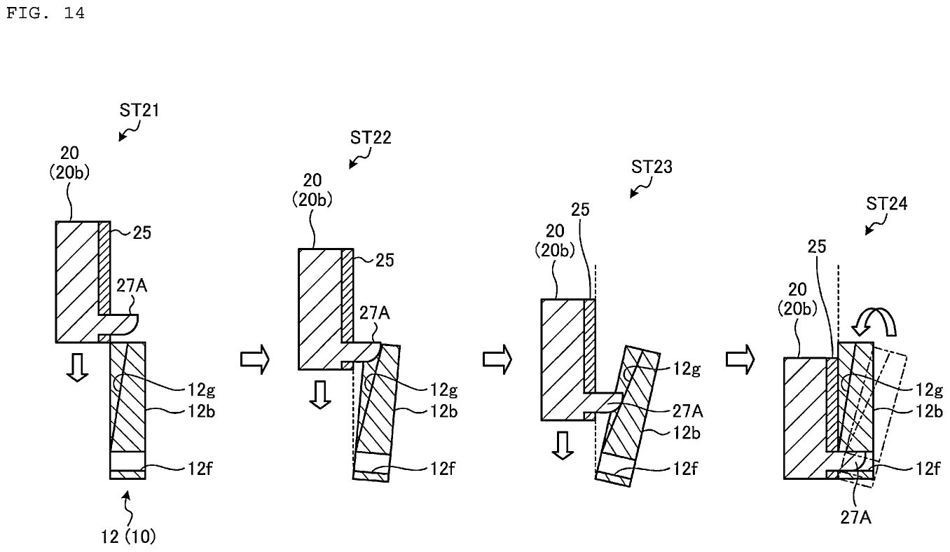

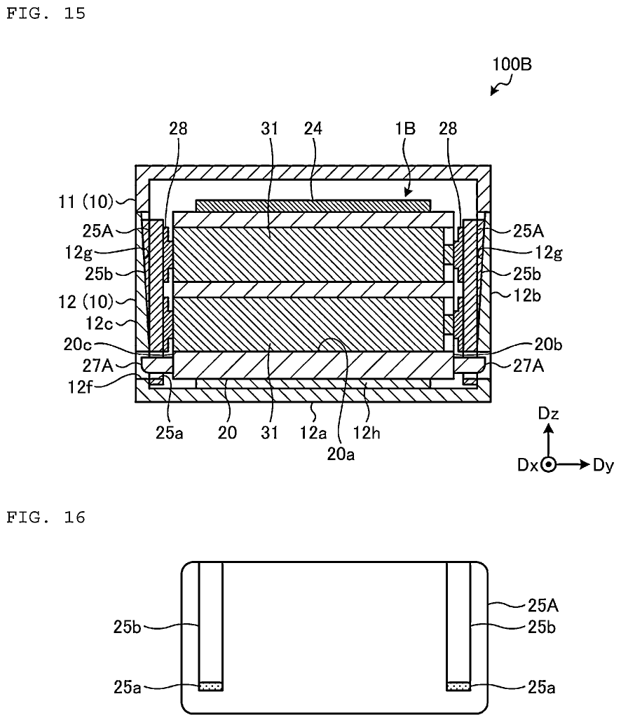

FIG. 15 is a sectional view schematically illustrating a battery pack according to a first modification of the second embodiment. FIG. 16 is a side view schematically illustrating a heat dissipation sheet. As illustrated in FIGS. 15 and 16, a battery pack 100B according to the first modification of the second embodiment is different from the above-described second embodiment in that a heat dissipation sheet 25A has protrusions 25b extending along the groove portions 12g at positions overlapping the groove portions 12g.

As illustrated in FIG. 15, when a battery cell assembly 1B is stored in the second exterior case 12 and the protruding portion 27A is inserted into the through hole 12f, the protrusion 25b of the heat dissipation sheet 25A is provided in close contact with the inclined surface of groove portion 12g. Although not illustrated in FIG. 15, in the region where the groove portion 12g is not provided, a portion of the heat dissipation sheet 25A where the protrusion 25b is not provided and portions of the side plates 12b and 12c where the groove portion 12g is not provided are provided in close contact with each other.

As illustrated in FIG. 16, the protrusion 25b of the heat dissipation sheet 25A extends continuously from the opening 25a to the upper end of the heat dissipation sheet 25A. The protrusion 25b is formed to have the same width as the opening 25a. However, the present disclosure is not limited thereto, and the protrusion 25b is formed to have a width equal to that of the groove portion 12g or a width slightly smaller than that of the groove portion 12g. In addition, two protrusions 25b are arranged side by side on the heat dissipation sheet 25A corresponding to the groove portions 12g of the second exterior case 12.

In the first modification, as compared with the second embodiment, when the groove portions 12g are provided in the side plates 12b and 12c of the second exterior case 12, it is possible to form a high close contact state with the side plates 12b and 12c of the second exterior case 12 in the entire region of the heat dissipation sheet 25A (the region including the protrusions 25b facing the groove portions 12g).

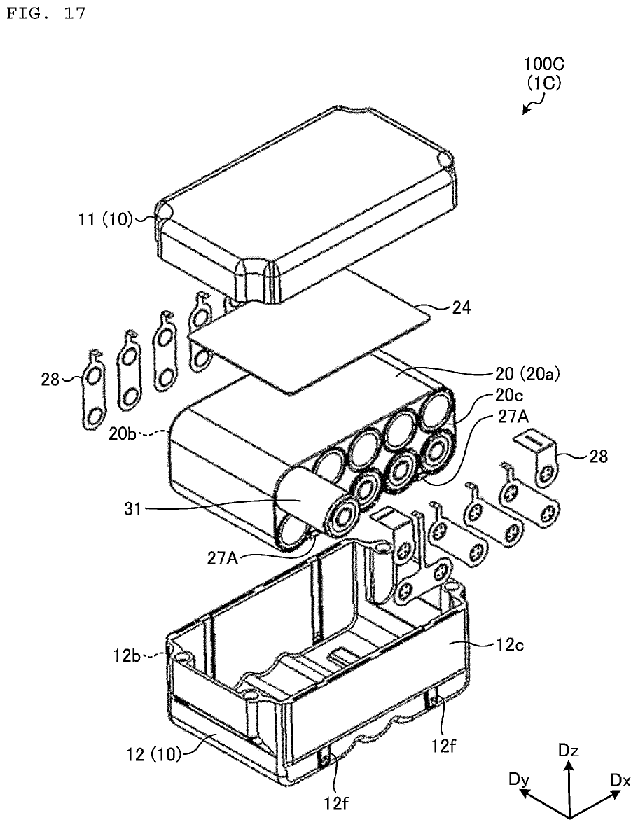

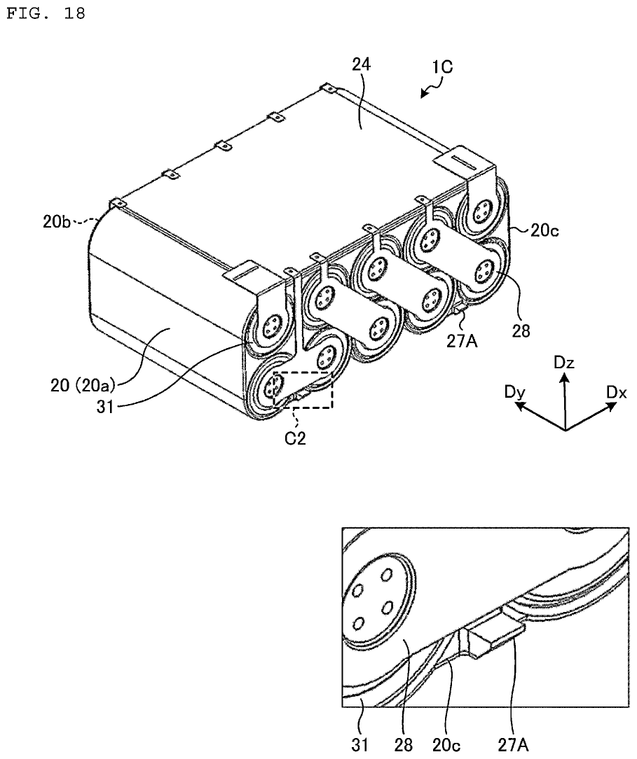

FIG. 17 is an exploded perspective view schematically illustrating a battery pack and a battery holder according to a third embodiment in an exploded manner. FIG. 18 is an enlarged perspective view illustrating a protruding portion in a part of the battery holder according to the third embodiment. Note that, in FIG. 18, a region C2 surrounded by a dotted line is enlarged together with a perspective view of the battery cell assembly 1C.

As illustrated in FIGS. 17 and 18, a battery pack 100C according to the third embodiment is different from the above-described embodiments and the first modification in that the battery cell assembly 1C does not have the heat dissipation sheet 25. That is, in the battery cell assembly 1C, the battery connecting portion 28 is arranged to be exposed to the outside in the second direction Dy, and a member covering the battery connecting portion 28 is not provided.

As illustrated in FIG. 18, the protruding portions 27A are provided in regions of the side portion 20c of the battery holder 20 that do not overlap the battery connecting portions 28. Note that the arrangement relationship between the protruding portions 27A and the battery connecting portions 28 is similar in each of the above-described embodiments.

FIG. 19 is a sectional view schematically illustrating the battery pack according to the third embodiment. As illustrated in FIG. 19, in the third embodiment, the battery connecting portions 28 of the battery cell assembly 1C are in contact with the side plates 12b and 12c of the second exterior case 12. Also in the present embodiment, an operation example of storing the battery holder 20 in the second exterior case 12 is similar to that in FIG. 14 described above. That is, when the protruding portions 27A are inserted into the through holes 12f, the side plates 12b and 12c are elastically deformed so as to sandwich the battery cell assembly 1C in the second direction Dy, and a highly close contact state with the battery connecting portions 28 is created. Accordingly, in the configuration without the heat dissipation sheet 25, the heat generated from the battery cells 31 is satisfactorily transferred to the second exterior case 12 via the battery connecting portions 28 formed of a metal plate.

A length L1 of the protruding portion 27A in the extending direction is longer than at least a thickness T3 of the battery connecting portion 28. In addition, the length L1 of the protruding portion 27A in the extending direction is shorter than a total thickness T4 of the battery connecting portion 28 and the side plate 12b. As a result, the tip of the protruding portion 27A is positioned inside the through hole 12f.

In the third embodiment, when the battery holder 20 is stored in the second exterior case 12, the side plates 12b and 12c are pushed and expanded by the protruding portions 27A, so that contact between the battery connecting portions 28 and the side plates 12b and 12c is suppressed. Therefore, when the battery pack 100C does not have the heat dissipation sheet 25 and the battery connecting portions 28 are provided to be exposed, it is possible to suppress the occurrence of breakage of the battery connecting portions 28 when the battery holder 20 is stored in the second exterior case 12.

Note that the third embodiment can also be combined with the first embodiment and the second embodiment described above. That is, in the first embodiment and the second embodiment, the heat dissipation sheet 25 may be omitted.

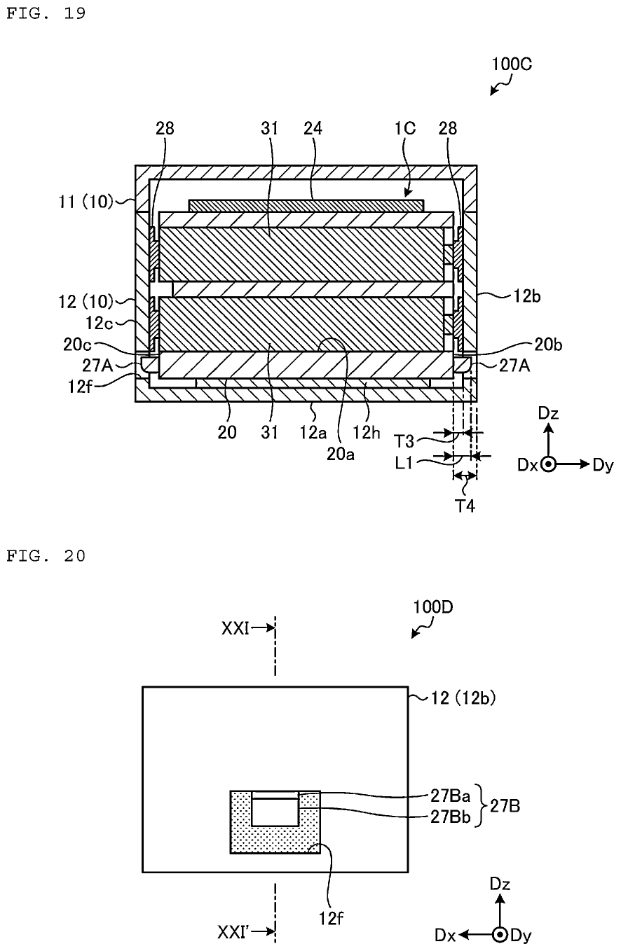

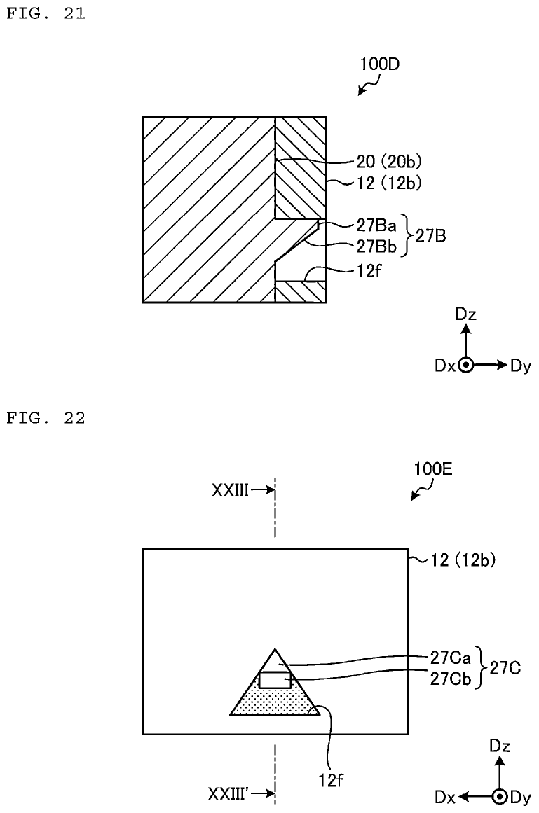

FIG. 20 is a side view illustrating a protruding portion of a battery holder and a through hole of an exterior case according to a second modification. FIG. 21 is a sectional view taken along line XXI-XXI′ of FIG. 20. Note that, in FIG. 21, in order to make the drawing easily viewable, members such as the battery connecting portion 28 and the heat dissipation sheet 25 are omitted, and configurations of a protruding portion 27B and the through hole 12f of the side plate 12b are illustrated.

As illustrated in FIG. 20, in a battery pack 100D of the second modification, the protruding portion 27B has a first portion 27Ba having a rectangular shape and a second portion 27Bb integrally formed on the lower side of the first portion 27Ba in a side view from the extending direction (second direction Dy) of the protruding portion 27B. The through hole 12f has a rectangular shape having a width and a height larger than those of the protruding portion 27B in a side view.

As illustrated in FIG. 21, the upper surface of the first portion 27Ba of the protruding portion 27B extends in a direction parallel to the second direction Dy and is formed flat. The upper surface of the first portion 27Ba is in contact with the upper end side of the through hole 12f to define the height position of the battery holder 20. The lower surface of the second portion 27Bb of the protruding portion 27B is an inclined surface. That is, the second portion 27Bb of the protruding portion 27B has a tapered shape that becomes thinner as a distance from the side portion 20b increases (as a distance to the tip decreases) in the extending direction (second direction Dy). The inclined surface of the second portion 27Bb is arranged away from the lower end side of the through hole 12f.

In the protruding portion 27B of the second modification, the second portion 27Bb has the inclined surface, so that a force necessary for storing the battery holder 20 in the second exterior case 12 can be reduced, and the battery holder 20 can smoothly move downward (toward the through hole 12f) while the side plates 12b and 12c are pushed and expanded. In addition, since the first portion 27Ba of the protruding portion 27B has a constant thickness, in a state where the protruding portion 27B is inserted into the through hole 12f, the protruding portion 27B is hardly deformed with respect to the force in the direction of pulling out the battery holder 20 upward. That is, in the second modification, when an impact such as dropping or vibration is applied, it is possible to suppress separation of the protruding portion 27B from the through hole 12f.

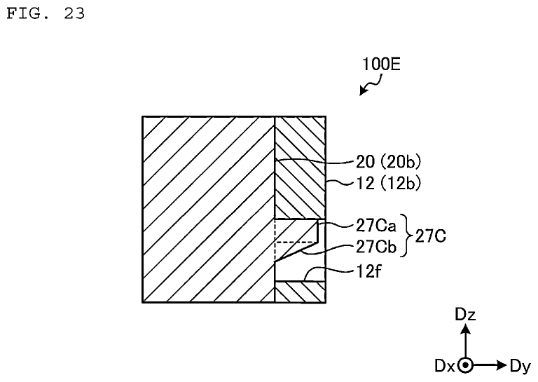

FIG. 22 is a side view illustrating a protruding portion of a battery holder and a through hole of an exterior case according to a third modification. FIG. 23 is a sectional view taken along line XXIII-XXIII′ of FIG. 22. As illustrated in FIG. 22, in a battery pack 100E of the third modification, a protruding portion 27C has a first portion 27Ca having a triangular shape and a second portion 27Cb integrally formed on the lower side of the first portion 27Ca in a side view from the extending direction (second direction Dy) of the protruding portion 27C.

The through hole 12f has a triangular shape corresponding to the first portion 27Ca in a side view. In addition, the through hole 12f has a triangular shape similar to the first portion 27Ca, and the top portion of the first portion 27Ca of the protruding portion 27C is arranged to coincide with the top portion of the through hole 12f. As a result, the upper surface of the first portion 27Ca is in contact with the upper end side of the through hole 12f, the height position of the battery holder 20 is defined, and the position in the first direction Dx is also defined.

As illustrated in FIG. 23, the first portion 27Ca of the protruding portion 27C is formed with a constant thickness along the extending direction. The lower surface of the second portion 27Cb of the protruding portion 27C is an inclined surface. That is, the second portion 27Cb of the protruding portion 27C has a tapered shape that becomes thinner as a distance from the side portion 20b increases (as a distance to the tip decreases) in the extending direction (second direction Dy). The inclined surface of the second portion 27Cb is arranged away from the lower end side of the through hole 12f.

Also in the protruding portion 27C of the third modification, the second portion 27Cb has the inclined surface, so that a force necessary for storing the battery holder 20 in the second exterior case 12 can be reduced, and the battery holder 20 can smoothly move downward (toward the through hole 12f) while the side plates 12b and 12c are pushed and expanded. In addition, since the first portion 27Ca has a triangular shape, as compared with the second modification, the protruding portion 27C is less likely to be deformed with respect to the force in the direction of pulling out the battery holder 20 upward, and the protruding portion 27C can be suppressed from being separated from the through hole 12f.

Note that the protruding portions 27B and 27C of the second modification and the third modification can be combined with the above-described embodiments and the first modification.

In addition, the materials, thicknesses, dimensions, and the like of the configurations illustrated in the above-described embodiments and modifications are merely examples, and may be appropriately changed.

Note that it is to be noted that the embodiments described above are intended to facilitate understanding of the present disclosure, but not intended to construe the present disclosure in any limited way. The present disclosure can be modified or improved without departing from the gist thereof, and equivalents thereof are also included in the present disclosure.

### DESCRIPTION OF REFERENCE SYMBOLS

1, 1A, 1B, 1C: Battery cell assembly
10: Exterior case
11: First exterior case
11a: Top plate
11b: Side plate
12: Second exterior case
12a: Bottom plate
12b, 12c, 12d, 12e: Side plate
12f: Through hole
12g: Groove portion
12h: Pedestal
20: Battery holder
20a: Battery storage portion
20b, 20c: Side portion
24: Substrate
25, 25A: Heat dissipation sheet
25a: Opening
25b: Protrusion
27, 27A, 27B, 27C: Protruding portion
28: Battery connecting portion
31: Battery cell
100, 100A, 100B, 100C, 100D, 100E: Battery pack

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery cell assembly including a plurality of battery cells and a battery holder in which the plurality of battery cells are stored; and
an exterior case that includes a bottom plate and a plurality of side plates intersecting with the bottom plate at a peripheral edge of the bottom plate and stores the battery holder,
wherein the battery holder has a side portion facing the side plate of the exterior case,
the battery holder is provided with at least one protruding portion protruding from the side portion,
the side plate of the exterior case is provided with a through hole into which the protruding portion is inserted,
a portion of the battery cell assembly is in contact with an inner surface of the side plate of the exterior case,
the plurality of side plates of the exterior case include a first side plate and a second side plate opposed to the first side plate,
the side portion of the battery holder includes a first side portion facing the first side plate and a second side portion on a side opposite to the first side portion and facing the second side plate, and
a distance between an outer surface corresponding to the first side portion and an outer surface corresponding to the second side portion of the battery cell assembly when the battery holder is not stored in the exterior case is equal to or longer than a distance between the first side plate and the second side plate of the exterior case.

2. The battery pack according to claim 1, wherein
the first side plate is provided with a plurality of the through holes, and the second side plate is provided with a plurality of the through holes,
the plurality of through holes are provided at positions closer to the bottom plate than upper ends of the first side plate and the second side plate, and
the first side portion and the second side portion of the battery holder are respectively provided with a plurality of the protruding portions at positions closer to the bottom plate than upper ends of the first side plate and the second side plate, and the plurality of protruding portions are respectively inserted into the plurality of through holes of the first side plate and the plurality of through holes of the second side plate.

3. The battery pack according to claim 1, wherein at least one of the protruding portions has a tapered shape that becomes thinner as a distance from the side portion increases, an upper surface of the protruding portion extends in a direction parallel to the bottom plate, and a lower surface of the protruding portion is inclined with respect to the upper surface.

4. The battery pack according to claim 1, wherein a pedestal that supports the battery holder is provided on the bottom plate of the exterior case.

5. The battery pack according to claim 1, wherein
a groove portion extending between the through hole and an upper end of the side plate is provided on the inner surface of the side plate, and
the groove has an inclined surface that becomes deeper from the through hole toward the upper end of the side plate.

6. The battery pack according to claim 5, further comprising a heat dissipation sheet provided between the side portion of the battery holder and the side plate of the exterior case,
wherein the heat dissipation sheet has a protrusion extending along the groove portion at a position overlapping the groove.

7. The battery pack according to claim 1, wherein
the battery cell is a cylindrical type,
the side portion of the battery holder is provided on one end side in an extending direction of the battery cell,
the battery pack includes a heat dissipation sheet provided between the side portion of the battery holder, the one end side of the battery cell, and the side plate of the exterior case, and
the heat dissipation sheet has an opening at a position overlapping the protruding portion.

8. The battery pack according to claim 1, wherein
a first distance between the first side plate and the second side plate at the upper ends is larger than a second distance between the first side plate and the second side plate in a state where the battery holder is not stored in the exterior case when the protruding portion is located between the upper end of the first side plate and the through hole of the first side plate when the battery holder is stored in the exterior case, and
a third distance between the first side plate and the second side plate at the upper ends is smaller than the first distance when the protruding portion is inserted into the through hole.

9. The battery pack according to claim 1, wherein
the protruding portion of the battery holder is formed of a material having a flexural modulus of 2000 MPa or more and a tensile elongation of less than 5%, and
the exterior case is formed of a material having a flexural modulus of less than 2000 MPa and a tensile elongation of 5% or more.
